(19) United States
(12) Patent Application Publication
(10) Pub. No.: US 2023/0041254 A1
(43) Pub. Date: Feb. 9, 2023

(54) ADJUSTMENT METHOD AND ADJUSTMENT DEVICE

(71) Applicant: SEIKO EPSON CORPORATION, Tokyo (JP)

(72) Inventor: Masataka YOSHIDA, Azumino-shi (JP)

(21) Appl. No.: 17/880,789

(22) Filed: Aug. 4, 2022

(30) Foreign Application Priority Data
Aug. 4, 2021 (JP) 2021-128038

(51) Int. Cl. H04N 9/31

(52) U.S. Cl. CPC H04N 9/3185; H04N 9/3194

(57) ABSTRACT

An adjustment method includes the steps of displaying, by a first display device, a first image used to help an input operation for performing an adjustment of a second display device different from the first display device, displaying, by the second display device, the first image and a second image in which a result of the adjustment is reflected, and outputting an adjustment parameter used to perform the adjustment to the second display device based on the input operation.

The present application is based on, and claims priority from JP Application Serial Number 2021-128038, filed Aug. 4, 2021, the disclosure of which is hereby incorporated by reference herein in its entirety.

### BACKGROUND

### 1. Technical Field

The present disclosure relates to an adjustment method and an adjustment device.

### 2. Related Art

There has been known a system capable of performing an adjustment of an external display device coupled to a computer based on an input operation to the computer. In a system described in JP-A-2011-215530, it is possible to adjust a screen size, an arrangement, and so on with respect to a plurality of video screens included in a projection screen projected by a projector based on an input operation to a computer.

However, in the system described in JP-A-2011-215530, an operation screen for performing the adjustment described above is displayed on a display screen provided to the computer. Therefore, when it is attempted to perform an adjustment while checking an adjustment result with an actual projection screen, it is necessary for the user to watch both of the display screen and the projection screen, which damages the convenience of the user.

### SUMMARY

An adjustment method is an adjustment method of performing, by an adjustment device coupled to a first display device and an input device configured to receive an input operation, an adjustment of a second display device different from the first display device, the adjustment method includes the steps of making the first display device display a first image used to help the input operation for performing the adjustment, making the second display device display the first image and a second image in which an adjustment result of the adjustment is reflected, and generating, based on the input operation received by the input device, an adjustment parameter for adjusting the second display device to output the adjustment parameter generated to the second display device.

An adjustment device is an adjustment device which is coupled to a first display device and an input device configured to receive an input operation, and which is configured to perform an adjustment of a second display device different from the first display device based on the input operation, makes the first display device display a first image used to help the input operation for performing the adjustment, makes the second display device display the first image and a second image in which an adjustment result of the adjustment is reflected, and generates, based on the input operation received by the input device, an adjustment parameter for adjusting the second display device to output the adjustment parameter generated to the second display device.

### BRIEF DESCRIPTION OF THE DRAWINGS

FIG. 1 is an explanatory diagram showing a display system in a first embodiment.

FIG. 2 is a block diagram showing a schematic configuration of the display system and an internal configuration of a computer.

FIG. 3 is a block diagram showing an internal configuration of a projector.

FIG. 4 is a block diagram showing a schematic configuration of a projecting unit.

FIG. 5 is a flowchart for explaining an adjustment method in projection image adjustment processing.

FIG. 6 is a diagram showing an operation image to be displayed on a display device.

FIG. 7 is a diagram showing an operation image to be displayed on the display device.

FIG. 8 is a diagram showing a projection image projected by the projector.

FIG. 9 is a diagram showing an operation image including an error image.

FIG. 10 is a diagram showing a projection image including an error image.

FIG. 11 is a diagram showing a projection image projected by the projector.

FIG. 12 is an explanatory diagram showing a display system in a second embodiment.

FIG. 13 is a diagram showing an operation image to be displayed on a display device in the second embodiment.

FIG. 14 is a diagram showing a projection image to be projected by a projector in the second embodiment.

### DESCRIPTION OF EXEMPLARY EMBODIMENTS

### 1. First Embodiment

A display system in a first embodiment will hereinafter be described with reference to the drawings.

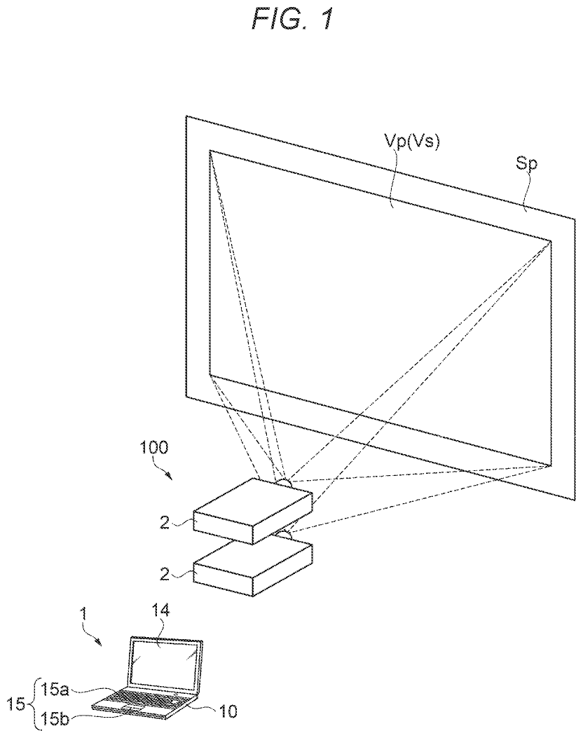

FIG. 1 is an explanatory diagram showing the display system 100 according to the present embodiment.

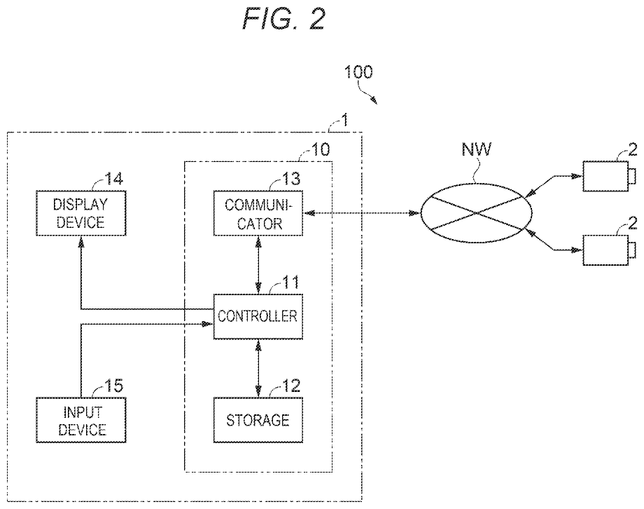

As shown in FIG. 1, the display system 100 is provided with a computer 1, and a plurality of projectors 2 for projecting images on a projection surface Sp such as a screen or a wall surface to thereby display the images. The plurality of projectors 2 and the computer 1 are each connected to a network NW (see FIG. 2), wherein the computer 1 is capable of controlling an operation of each of the projectors 2 via the network NW. The plurality of projectors 2 is installed so as to be able to display respective images the same as each other in a superimposed manner. It should be noted that hereinafter the image to individually be projected by each of the projectors 2 is also referred to as a “projection image Vp,” and an image formed by superimposing these images is also referred to as a “stacked image Vs.” By projecting the same images from the plurality of projectors 2 in a superimposed manner, it becomes possible to display the image at higher luminance than in the case of a single projector. Although in the present embodiment, there is illustrated the display system 100 including two projectors 2, the number of the projectors 2 can be three or more.

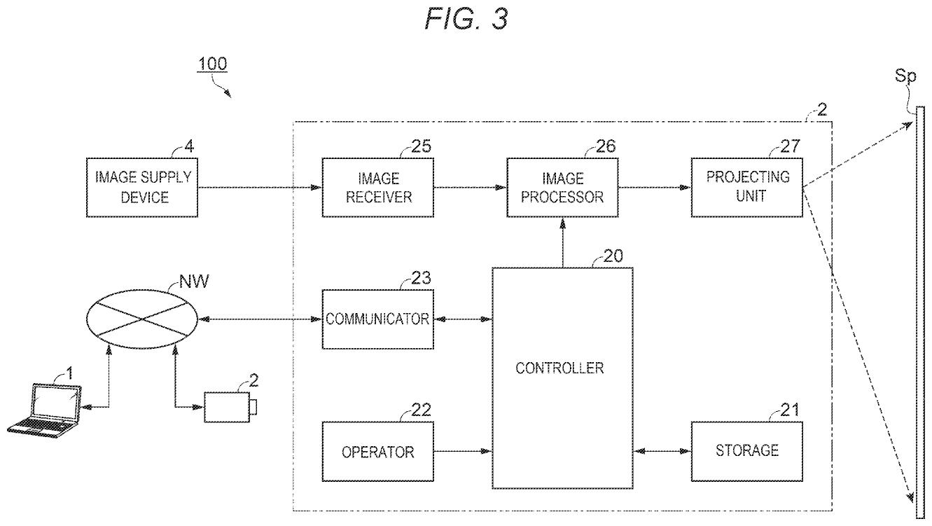

The configuration of the display system 100 shown in FIG. 1 is a configuration required when performing an initial setting and a variety of adjustments of the projectors 2, and when subsequently making the projectors 2 display a desired content image as the stacked image Vs, an external image supply device 4 (see FIG. 3) is coupled to each of the projectors 2, and then image data corresponding to the content image is supplied from the image supply device 4. It should be noted that it is possible to arrange that the image data corresponding to the content image is supplied from the computer 1 via the network NW.

FIG. 2 is a block diagram showing a schematic configuration of the display system 100 and an internal configuration of the computer 1.

As shown in FIG. 2, the computer 1 is provided with a computer main body 10 configured including a controller 11, a storage 12, and a communicator 13, a display device 14, and an input device 15. The display device 14 and an input device 15 are coupled to the controller 11 in the computer main body 10. In the present embodiment, as the computer 1, there is illustrated a notebook computer including the computer main body 10, the display device 14, and the input device 15 configured integrally with each other, but the computer 1 can be a desktop computer coupled to an external display device 14 and an external input device 15. The computer main body 10 corresponds to an adjustment device.

The controller 11 is configured including at least one processor, a RAM (random access memory), a ROM (read only memory), and so on. The controller 11 operates in accordance with a program stored in the ROM, or a program retrieved from the storage 12 into the RAM to thereby integrally control the operation of the computer 1.

The storage 12 is configured including a storage device such as a hard disk drive or a solid-state drive. The storage 12 stores an operating system (OS) installed, application programs, a variety of data, and so on. In the storage 12 in the present embodiment, there is installed a projection image adjustment program not shown. The projection image adjustment program is an application program for adjusting a shape, an image quality, and so on of the projection image Vp of each of the projectors 2.

The communicator 13 is configured including a variety of circuits for performing communication with an external device via the network NW. The communicator 13 in the present embodiment performs communication with the plurality of projectors 2 which is connected via the network NW based on the control by the controller 11. As an aspect of the communication, it is possible to adopt wired communication or wireless communication.

The display device 14 is configured including a display device such as a liquid crystal display or an organic EL (Electro Luminescence) display, and displays an image based on the control by the controller 11. The display device 14 corresponds to a first display device.

The input device 15 is constituted by a keyboard 15a (see FIG. 1), a touch pad 15b (see FIG. 1) as a pointing device, and so on, and receives an input operation by the user to output information corresponding to the input operation to the controller 11. It should be noted that when an external keyboard and a pointing device such as a mouse are coupled to the computer main body 10, these devices also function as the input device 15.

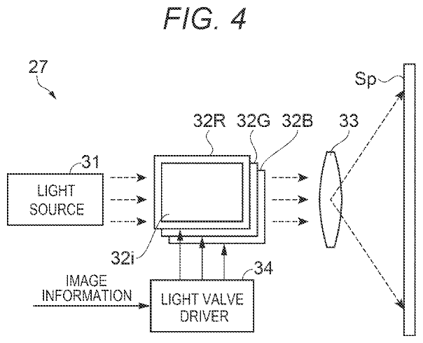

FIG. 3 is a block diagram showing an internal configuration of the projector 2, and FIG. 4 is a block diagram showing a schematic configuration of a projecting unit 27 provided to the projector 2. It should be noted that in the present embodiment, the plurality of projectors 2 has a common configuration.

As shown in FIG. 3, the projector 2 is configured integrally including a controller 20, a storage 21, an operator 22, a communicator 23, an image receiver 25, an image processor 26, and a projecting unit 27. The projector 2 projects the projection image Vp on the projection surface Sp from the projecting unit 27 based on the image data input to the image receiver 25 or the communicator 23. The projector 2 is a display device different from the display device 14, and corresponds to a second display device.

The controller 20 is configured including a single processor or a plurality of processors, and operates in accordance with a control program stored in the storage 21 to thereby integrally control the operation of the projector 2.

The storage 21 is configured including memory devices such as a RAM and a ROM. The RAM is used for temporary storage of a variety of types of data and so on, and the ROM stores the control program and control data for controlling the operation of the projector 2, the image data, and so on.

The operator 22 is provided with a plurality of operation keys (not shown) for the user to provide a variety of instructions to the projector 2. When the user operates a variety of operation keys of the operator 22, the operator 22 outputs an operation signal corresponding to the operation content by the user to the controller 20. It should be noted that it is also possible to adopt a configuration of using a remote controller (not shown) capable of a remote operation as the operator 22. In this case, the remote controller transmits an operation signal of an infrared ray corresponding to the operation content by the user, and then a remote control signal receiver not shown receives the operation signal to transmit the operation signal to the controller 20.

The communicator 23 is configured including a variety of circuits for performing communication with an external device via the network NW. The communicator 23 in the present embodiment is connected to the computer 1 and the other projector 2 via the network NW, and performs transmission/reception of the variety of types of information with these devices based on the control by the controller 20.

The image receiver 25 is coupled to the external image supply device 4 such as an image reproduction device. The image receiver 25 is supplied with the image data corresponding to the content image from the image supply device 4, and outputs the image data to the image processor 26.

The image processor 26 performs adjustment processing on the image data input from the image receiver 25, or the image data transmitted from the computer 1 or the like via the network NW based on the control by the controller 20, and then outputs the image data on which the processing has been performed to a light valve driver 34 (see FIG. 4) in the projecting unit 27. For example, the image processor 26 performs the processing of correcting a geometric distortion on the image data to correct the aspect of the projection image Vp, namely a contour shape of the projection image Vp, or a distortion of an image inside the projection image Vp. In this case, the image processor 26 divides the projection image Vp into a plurality of small areas, and performs a correction based on geometric correction parameters determined for each of the small areas to thereby correct the geometric distortion. The geometric correction parameters for each of the small areas are generated by the computer 1, transmitted to the projector 2, and then stored in the storage 21. The geometric correction parameters correspond to adjustment parameters.

Further, the image processor 26 is capable of obtaining the image data generated by the controller 20, or the image data stored in the storage 21 from the controller 20 instead of the image data corresponding to the content image, and then outputting the image data to the projecting unit 27. It should be noted that the image receiver 25 and the image processor 26 can be constituted by a single processor, a plurality of processors, or the like, or can also be constituted by a dedicated processing device such as an ASIC (Application Specific Integrated Circuit) or an FPGA (Field Programmable Gate Array).

As shown in FIG. 4, the projecting unit 27 is configured including a light source 31, three liquid crystal light valves 32R, 32G, and 32B as light modulation devices, a projection optical system 33, a light valve driver 34, and so on. The projecting unit 27 modulates the light emitted from the light source 31 with the liquid crystal light valves 32R, 32G, and 32B to thereby form image light, and then projects the image light from the projection optical system 33 including at least one of a lens and a mirror to thereby display the image on the projection surface Sp.

The light source 31 is configured including a discharge type light source lamp such as a super high-pressure mercury lamp or a metal halide lamp, or a solid-state light source such as a light emitting diode or a semiconductor laser. The light emitted from the light source 31 is converted into light having a substantially uniform intensity of luminance distribution by an integrator optical system not shown, and is then separated into colored light components of red, green, and blue as the three primary colors of light by a color separation optical system not shown, and then the colored light components respectively enter the liquid crystal light valves 32R, 32G, and 32B.

The liquid crystal light valves 32R, 32G, and 32B are each formed of a transmissive liquid crystal panel having a liquid crystal material encapsulated between a pair of transparent substrates, and so on. The liquid crystal panels are each provided with a pixel area 32i having a rectangular shape and constituted by a plurality of pixels arranged in a matrix, and are each arranged so that a drive voltage can be applied to the liquid crystal material pixel by pixel.

The light valve driver 34 forms an image in the pixel area 32i of each of the liquid crystal light valves 32R, 32G and 32B. Specifically, the light valve driver 34 applies drive voltages corresponding to the image data input from the image processor 26 to the respective pixels in the pixel area 32i to thereby set the pixels to respective light transmittances corresponding to the image data. The light emitted from the light source 31 is transmitted through the pixel area 32i of each of the liquid crystal light valves 32R, 32G, and 32B to thereby be modulated pixel by pixel, and thus, the image light corresponding to the image data is formed for each of the colored light beams. The image light beams of the respective colors thus formed are combined pixel by pixel by a color combining optical system not shown to turn to the image light beam representing a color image, and are then projected on the projection surface Sp in an enlarged manner by the projection optical system 33. As a result, on the projection surface Sp, there is displayed the projection image Vp based on the image data input from the image processor 26.

Then, an adjustment of the projector 2 to be performed in advance of the projection of the content image by the display system 100 will be described.

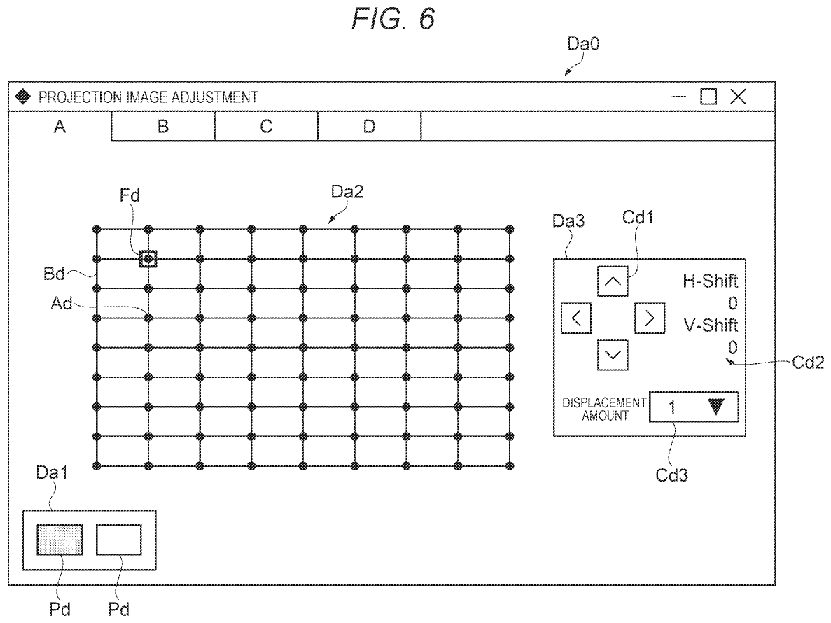

First, the user installs the projectors 2 so that the projection images Vp of the respective projectors 2 each become in an appropriate state. Specifically, as shown in FIG. 1, the user installs the projectors 2 so that the sizes and the positions of the projection images Vp of the respective projectors 2 coincide with each other. Subsequently, when the user instructs the computer 1 to start up the projection image adjustment program, the computer 1 starts the projection image adjustment processing for adjusting the projectors 2 in accordance with the projection image adjustment program. In the present embodiment, the computer 1 performs the adjustment for correcting the geometric distortion of the projection image Vp as the projection image adjustment processing. Specifically, the computer 1 performs the processing of generating the geometric correction parameters for correcting the geometric distortion based on positions of adjustment points Ad (see FIG. 6) displaced in accordance with the input operation by the user.

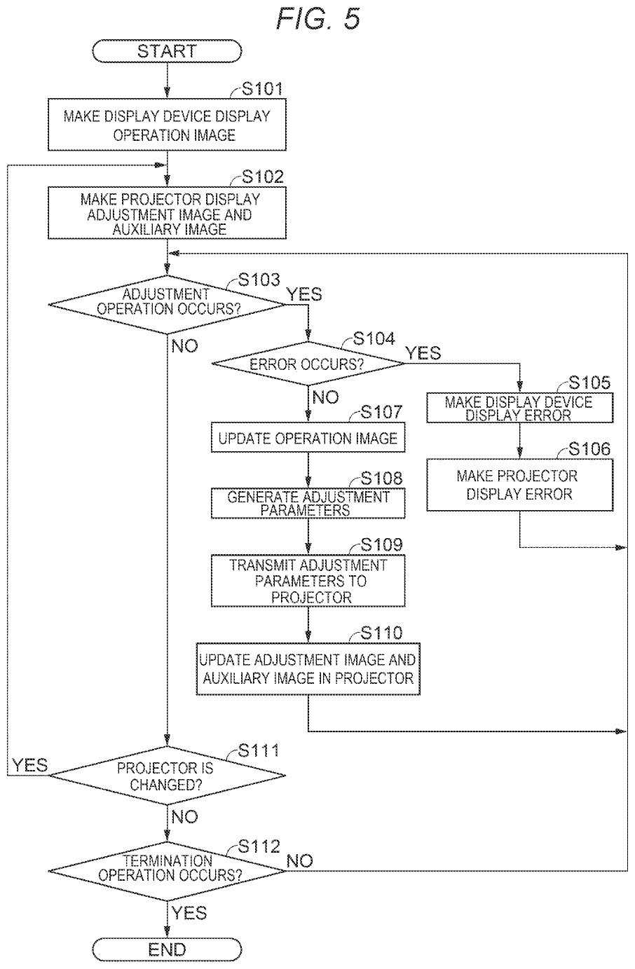

FIG. 5 is a flowchart for explaining an adjustment method in the projection image adjustment processing.

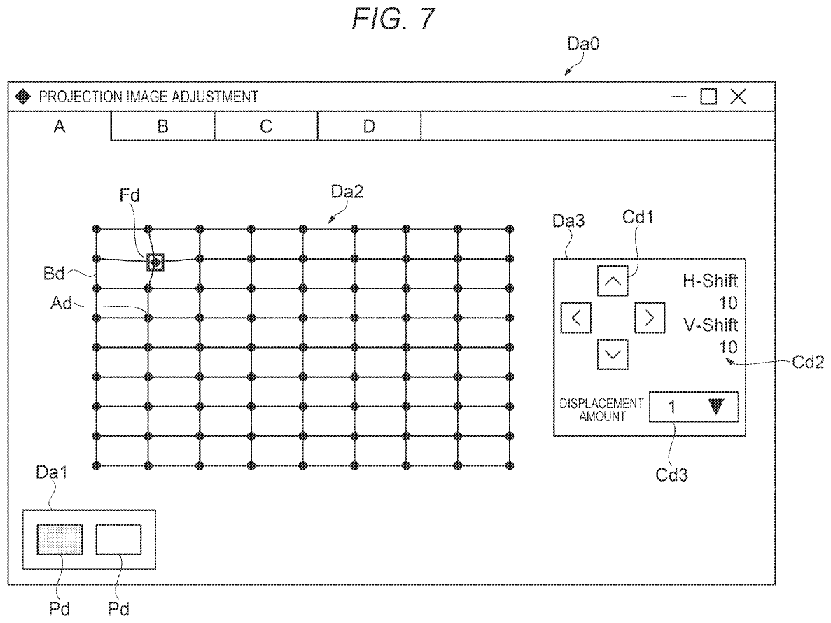

As shown in FIG. 5, in the step S101, the controller 11 of the computer 1 makes the display device 14 display an operation image Da0 for the geometric correction. As shown in FIG. 6, in the operation image Da0, there are included a selection image Da1 for selecting the projector 2 as an adjustment target, an adjustment image Da2 in which a plurality of adjustment points Ad is arranged, and an auxiliary image Da3 for helping an input operation for performing the adjustment. As shown in FIG. 7, by selecting the projector 2 as the adjustment target in the selection image Da1, then selecting desired one of the adjustment points Ad in the adjustment image Da2, and then displacing the adjustment point Ad to a desired position, it is possible for the user to instruct the geometric correction in accordance with the position of the adjustment point Ad which has been displaced. For the selection of the projector 2, the selection of the adjustment point Ad, and the displacement of the adjustment point Ad, there is used the input device 15 such as the keyboard 15a or the pointing device.

In the selection image Da1, there are displayed panels Pd for the respective projectors 2 connected to the network NW, and in each of the panels Pd, there is described information (not shown) such as a name or a VP address of the projector 2. It is possible for the user to select the projector 2 as the adjustment target with reference to the information described above. Out of the panels Pd displayed in the selection image Da1, the panel Pd of the projector 2 selected as the adjustment target is displayed with a different color from a color of the rest of the panels Pd, and thus, it is arranged that the projector 2 currently selected can easily be identified.

In the adjustment image Da2, the plurality of adjustment points Ad is arranged in a matrix, and the two adjustment points Ad adjacent to each other in a vertical direction or a horizontal direction are coupled to each other with a straight line Bd. One of the adjustment points Ad is surrounded by a rectangular mark Fd different in color from the adjustment points Ad, which shows the fact that the adjustment point Ad is currently selected. In the present embodiment, the adjustment points Ad are arranged in a 9×9 matrix. It should be noted that the arrangement of the adjustment points Ad is not limited thereto. Further, the arrangement of the adjustment points Ad can be designated by the user.

In the auxiliary image Da3, there are included four arrow buttons Cd1 corresponding respectively to up, down, left, and right, a coordinate display Cd2 for displaying the coordinate of the adjustment point Ad currently selected, and a displacement amount designator Cd3 for designating a unit displacement amount as an amount of the displacement of the adjustment point Ad achieved by a single operation by the number of pixels.

It is possible for the user to designate the displacement direction and the displacement amount of the adjustment point Ad by displacing the adjustment point Ad with a drag operation using a pointing device, and in addition, by operating the direction key in the keyboard 15a a necessary number of times, or performing a click operation of the arrow button Cd1 a necessary number of times with the pointing device. When a displacement of the adjustment point Ad is instructed by the user, the controller 11 displaces the adjustment point Ad on the adjustment image Da2, and at the same time, the coordinate of the adjustment point Ad having been displaced is displayed on the coordinate display Cd2. Further, the displacement amount designator Cd3 is formed as a pull-down menu, and it is possible for the user to designate a desired unit displacement amount from a plurality of unit displacement amounts (not shown) included in the pull-down menu using the keyboard 15a or the pointing device. The unit displacement amount thus designated is arranged to visually be recognized with the displacement amount designator Cd3.

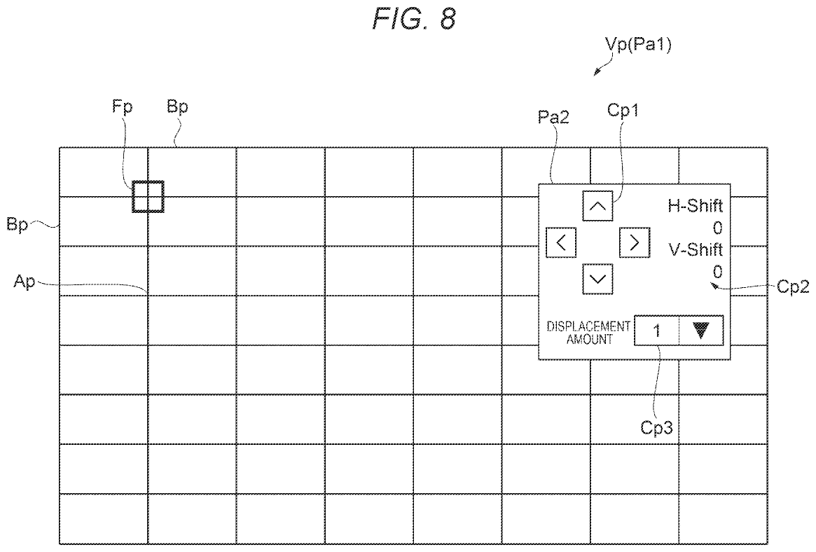

In the step S102, the controller 11 transmits a control command to the projector 2 as the adjustment target via the communicator 13 to make the projecting unit 27 project an adjustment image Pa1 in which the adjustment result is reflected, and an auxiliary image Pa2 for helping the input operation for performing the adjustment as shown in FIG. 8. Images used as bases of these images are stored in advance in the storage 21 of the projector 2, and the controller 11 of the computer 1 designates these images using the control command to be transmitted. When the controller 20 of the projector 2 receives the control command from the computer 1, the controller 20 reads out the adjustment image Pa1 and the auxiliary image Pa2 designated by the control command from the storage 21, and then outputs these images to the image processor 26 to make the projecting unit 27 project these images on the projection surface Sp.

The adjustment image Pa1 to be projected by the projector 2 is an image corresponding to the adjustment image Da2 to be displayed on the display device 14, and is displayed in the entire area of the projection image Vp. The adjustment image Pa1 includes a plurality of adjustment points Ap which corresponds respectively to the plurality of adjustment points Ad in the adjustment image Da2. Specifically, in the adjustment image Pa1, there is drawn a grid pattern with a plurality of straight lines Bp extending along the vertical direction and the horizontal direction, and intersections between the straight lines Bp form the adjustment points Ap. In the present embodiment, the adjustment points Ap are arranged in a 9×9 matrix similarly to the adjustment points Ad. One of the adjustment points Ap is surrounded by a rectangular mark Fp different in color from the straight lines Bp, which shows the fact that the adjustment point Ap is currently selected. The adjustment point Ap selected in the adjustment image Pa1 corresponds to the adjustment point Ad selected in the adjustment image Da2. The controller 11 of the computer 1 notifies the projector 2 of the information representing the adjustment point Ad selected on the adjustment image Da2 with the control command including the information. The controller 20 of the projector 2 recognizes the adjustment point Ad thus selected based on this control command, and then performs processing of adding the mark Fp to the corresponding one of the adjustment points Ap.

The auxiliary image Pa2 is displayed so as to be superimposed on the adjustment image Pa1. Therefore, there occurs the state in which some adjustment points Ap included in the adjustment image Pa1 are covered by the auxiliary image Pa2. The auxiliary image Pa2 is an image corresponding to the auxiliary image Da3 to be displayed on the display device 14, and includes four arrow buttons Cp1 corresponding respectively to up, down, left, and right, a coordinate display Cp2 for displaying the coordinate of the adjustment point Ap currently selected, and a displacement amount designator Cp3 for designating a unit displacement amount as an amount of the displacement of the adjustment point Ap achieved by a single operation by the number of pixels. The coordinate displayed in the coordinate display Cp2, and the unit displacement amount designated in the displacement amount designator Cp3 have the same values as the values displayed in the auxiliary image Da3. The controller 11 of the computer 1 includes these values in the control command and then transmits the control command to the computer 2. The controller 20 of the projector 2 recognizes the coordinate and the unit displacement amount based on this control command, and then generates the auxiliary image Pa2 in which these values are reflected respectively in the coordinate display Cp2 and the displacement amount designator Cp3. It should be noted that the controller 20 disposes the auxiliary image Pa2 at a position shifted from selected one of the adjustment points Ap so that selected one of the adjustment points Ap, namely the position to be the adjustment target on the adjustment image Pa1, is not covered by the auxiliary image Pa2.

In the step S103, the controller 11 determines whether or not the adjustment operation, namely the input operation related to the displacement of the adjustment point Ad, has been performed on the input device 15 by the user. The controller 11 makes the transition of the process to the step S104 when the adjustment operation has been performed (YES in the step S103), or makes the transition of the process to the step S111 when the adjustment operation has not been performed (NO in the step S103).

When the adjustment operation has been performed and the process has proceeded to the step S104, the controller 11 determines whether or not an error occurs due to the adjustment operation thus received. When, for example, the displacement amount of the adjustment point Ad displaced by the user has exceeded an allowable range, the controller 11 determines that the error occurs due to the adjustment operation. The controller 11 makes the transition of the process to the step S105 when the controller 11 has determined that the error occurs (YES in the step S104), or makes the transition of the process to the step S107 when the controller 11 has determined that the error does not occur (NO in the step 3104).

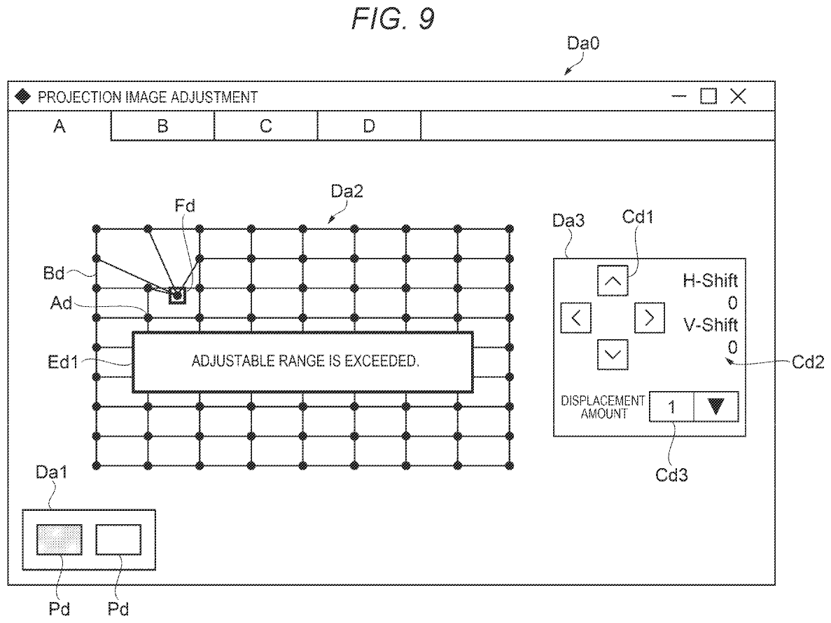

When it has been determined that the error occurs due to the adjustment operation, and thus, the process has proceeded to the step S105, the controller 11 makes the display device 14 display an error image Ed1 for giving notice of the error as shown in FIG. 9. The error image Ed1 is an image in which a message such as “ADJUSTABLE RANGE IS EXCEEDED.” is described on a background with a color high in visibility, and is displayed so as to be superimposed on the adjustment image Da2.

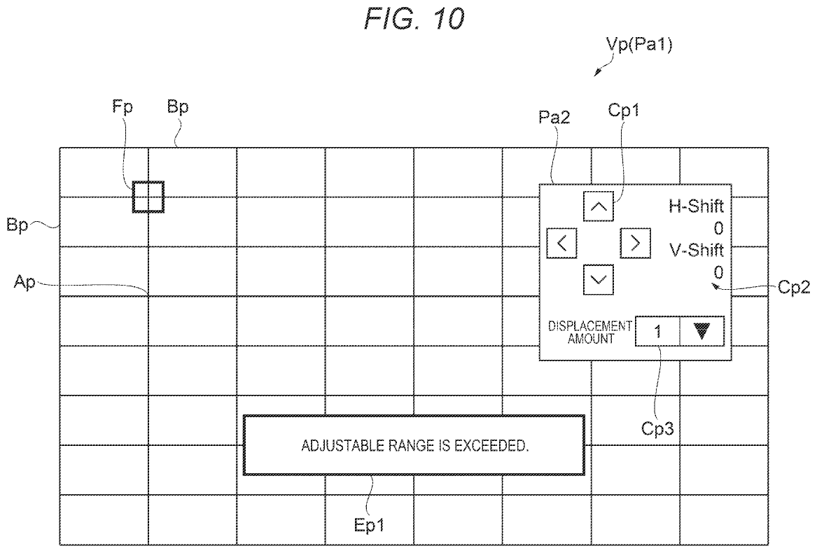

In the step S106, the controller 11 transmits the control command to the projector 2 as the adjustment target to make the projector 2 display an error image Ep1 for giving notice of the error also in the projection image Vp as shown in FIG. 10. Similarly to the error image Ed1, the error image Ep1 is an image in which a message such as “ADJUSTABLE RANGE IS EXCEEDED.” is described on a background with a color high in visibility, and is displayed so as to be superimposed on the adjustment image Pa1. In the storage 21 of the projector 2, there is stored a variety of error images including the error image Ep1, and the projector 2 displays the error image designated by the control command.

In contrast, when it has been determined that the error does not occur due to the adjustment operation, and thus, the process has proceeded to the step S107, the controller 11 updates the operation image Da0 in accordance with the adjustment operation. For example, when an input operation of displacing selected one of the adjustment points Ad has been performed as shown in FIG. 7, the controller 11 performs the processing of displacing the position of selected one of the adjustment points Ad in accordance with the input operation in the adjustment image Da2, and at the same time, performs the processing of displaying the coordinate having been displaced in the coordinate display Cd2 in the auxiliary image Da3.

In the step S108, the controller 11 generates the geometric correction parameters for correcting the geometric distortion in accordance with the displacement of the adjustment point Ad. When the adjustment points Ad are arranged in the 9×9 matrix as in the present embodiment, there exist 8×8=64 quadrangular small areas each having four adjustment points Ad adjacent to each other as the vertexes. The geometric correction parameters are parameters for performing the projective transformation on the projection image Vp for each of the small areas, and the controller 11 generates the geometric correction parameters for each of the small areas. When one adjustment point Ad is displaced, the controller 11 updates the geometric correction parameters of all of the small areas each having that adjustment point Ad as the vertex.

In the step S109, the controller 11 transmits the geometric correction parameters thus generated to the projector 2 as the adjustment target. The controller 20 of the projector 2 stores the geometric correction parameters thus received in the storage 21.

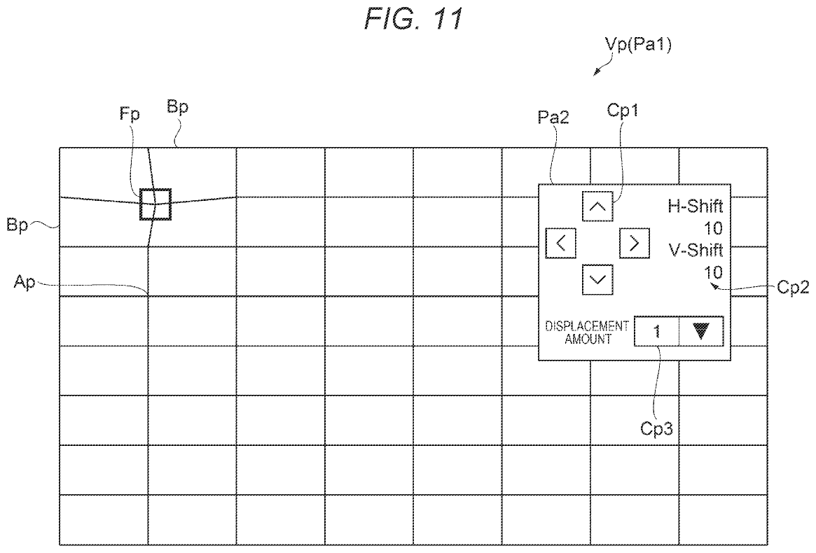

In the step S110, the controller 11 transmits the control command to the projector 2 as the adjustment target to make the projector 2 update the adjustment image Pa1 and the auxiliary image Pa2 projected by the projector 2, and then returns the process to the step 3103. In the control command of this case, there are included information representing selected one of the adjustment points Ad, information representing the displacement direction and the displacement amount, and so on. As shown in FIG. 11, when the controller 20 of the projector 2 receives the control command, the controller 20 changes the position of selected one of the adjustment points Ap, and at the same time, updates the coordinate displayed in the coordinate display Cp2 based on the control command. Thus, the adjustment result is reflected in the adjustment image Pa1 and the auxiliary image Pa2.

It should be noted that although not shown in the drawings, when the adjustment operation detected in the step S103 is the input operation not accompanied with the displacement of the adjustment point Ad, the generation and the transmission of the geometric correction parameters in the steps S108, S109 are not executed out of the steps S107 through S110, and only the steps S107, S110 are executed. For example, when the input operation of just selecting the adjustment point Ad is detected in the step S103, the controller 11 changes the adjustment point Ad to be attached with the mark Fd on the adjustment image Da2 in the step S107, and at the same time, transmits information representing the adjustment point Ad newly selected to the projector 2 as the control command to make the projector 2 update the adjustment point Ap to be attached with the mark Fp on the adjustment image Pa1. Further, for example, when the input operation of changing the unit displacement amount in the displacement amount designator Cd3 of the auxiliary image Da3 has been performed in the step S103, the controller 11 changes the unit displacement amount displayed in the displacement amount designator Cd3 in the step S107, and at the same time, transmits information representing the unit displacement amount newly designated to the projector 2 as the control command in the step S110 to make the projector 2 change the unit displacement amount displayed in the displacement amount designator Cp3 of the auxiliary image Pa2.

When the adjustment operation has not been detected in the step S103, and thus, the process has proceeded to the step S111, the controller 11 determines whether or not the input operation of changing the projector 2 as the adjustment target has been performed. When the input operation of changing the projector 2 as the adjustment target has been performed (YES in the step S111), the controller 11 performs processing (not shown) of changing the colors of the panels Pd in the selection image Da1, and processing (not shown) of making the projector 2 having been the adjustment target stop the projection of the adjustment image Pa1 and the auxiliary image Pa2, and then, returns the process to the step S102 to perform the processing of making the projector 2 which has newly become the adjustment target project the adjustment image Pa1 and the auxiliary image Pa2. In contrast, when the input operation of changing the projector 2 as the adjustment target has not been performed (NO in the step S111), the controller 11 makes the transition of the process to the step S112.

When the process has proceeded to the step S112, the controller 11 determines whether or not a termination operation, namely the input operation of terminating the program, has been performed on the input device 15. The controller 11 returns the process to the step S103 when the termination operation has not been performed (NO in the step S112), or terminates the flow when the termination operation has been performed (YES in the step S112).

Since the computer 1 in the present embodiment performs such control as described above, the auxiliary image Pa2 for helping the adjustment operation is displayed together with the adjustment image Pa1 in which the adjustment result is reflected in the projection image Vp projected by the projector 2 as the adjustment target. By looking at the auxiliary image Pa2, it is possible for the user to recognize the fact that the displacement of the adjustment points Ad, Ap can be achieved using the direction keys in the keyboard 15a, and moreover, it becomes possible for the user to recognize the coordinate of the adjustment points Ad, Ap and the unit displacement amount currently set.

As described hereinabove, according to the computer 1 and the adjustment method related to the present embodiment, the following advantages can be obtained.

(1) According to the present embodiment, the auxiliary image Da3 for helping the input operation for performing the adjustment is displayed on the display device 14, and at the same time, substantially the same auxiliary image Pa2 is also projected by the projector 2 as the adjustment target. Therefore, it becomes possible for the user to check both of the adjustment image Pa1 in which the adjustment result is reflected and the auxiliary image Pa2 only by looking at the projection image Vp projected by the projector 2. As a result, since the frequency of the user transferring the gaze to the display device 14 decreases, the convenience of the user is enhanced.

(2) According to the present embodiment, since the auxiliary image Pa2 to be displayed by the projector 2 is disposed so as to be superimposed at the position shifted from selected one of the adjustment points Ap, namely the position to be the target of the adjustment, in the adjustment image Pa1, it is possible to prevent the position to be the adjustment target from being covered by the auxiliary image Pa2.

(3) According to the present embodiment, when the error occurs due to the adjustment operation, the image for giving notice of the error is displayed on both of the display device 14 and the projector 2, and therefore, the frequency of transferring the gaze to the display device 14 further decreases.

It should be noted that in the embodiment described above, the auxiliary image Da3 to be displayed on the display device 14 and the auxiliary image Pa2 to be projected by the projector 2 correspond to a first image, and the adjustment image Pa1 to be projected by the projector 2 corresponds to a second image. Further, the error image Ed1 to be displayed on the display device 14, and the error image Ep1 to be projected by the projector 2 correspond to a third image.

### 2. Second Embodiment

A display system in a second embodiment will hereinafter be described with reference to the drawings.

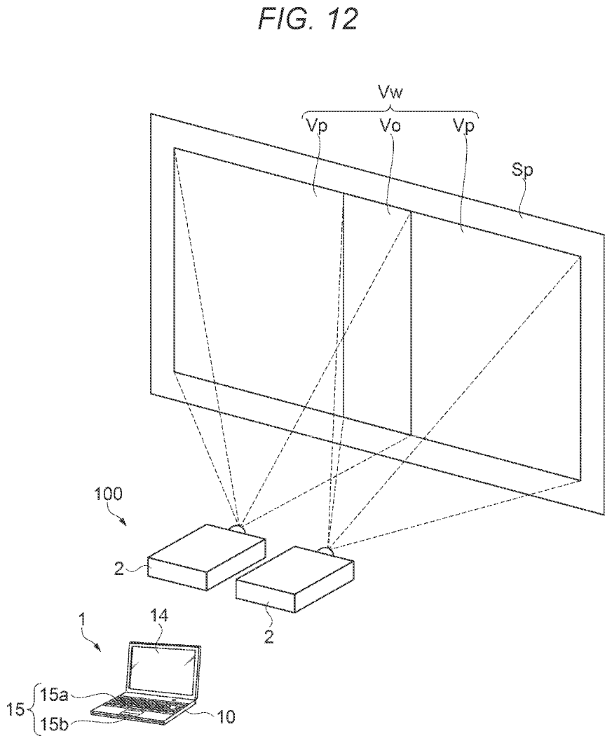

FIG. 12 is an explanatory diagram showing the display system 100 according to the second embodiment.

As shown in FIG. 12, the display system 100 according to the present embodiment is provided with the computer 1 and the plurality of projectors 2 similarly to the first embodiment. In the present embodiment, the plurality of projectors 2 is arranged so that the projection images Vp respectively projected from the projectors 2 are arranged side by side, and cooperates with each other to display a single large image. It should be noted that the large image formed by coupling the plurality of projection images Vp to each other is hereinafter also referred to as a “total image Vw.”

In FIG. 12, there are arranged the two projectors 2, and the two projection images Vp respectively projected from these projectors 2 are laterally arranged. Further, the total image Vw is formed of these two projection images Vp. It should be noted that the number of the projectors 2 is not limited to two, and can be three or more. Further, the arrangement direction is not limited to the lateral direction, and can be vertical direction, and it is possible to adopt a configuration in which the projection images are arranged in the lateral direction and the vertical direction to form a matrix.

The projectors 2 are installed so that the projection images Vp adjacent to each other partially overlap each other. Therefore, it is possible to display the total image Vw in a state in which no gap exists between the projection images Vp, and the projection images Vp are smoothly coupled to each other. An area Vo where the projection images Vp overlap each other is also referred to as an “overlapping area Vo.” The overlapping area Vo is an area where the plurality of projection images Vp overlap each other, and becomes higher in luminance than other areas without an adjustment, and is therefore subjected to an adjustment for uniformizing the luminance with other areas. Here, when the width of the overlapping area Vo is too narrow, a slight difference in color or luminance between the two projectors 2, if any, becomes conspicuous. In contrast, when the overlapping area Vo is too large, a range in which the image is blurred when the positions of two projection images Vp are slightly shifted from each other becomes large. Therefore, it is desirable for the overlapping area Vo to be set to an appropriate width.

In the present embodiment, as the projection image adjustment processing, there is described the processing of adjusting the position and the width of the overlapping area Vo in the projection image Vp when projecting the plurality of projection images Vp arranged side by side. This processing is also performed in advance of the projection of the content image by the display system 100.

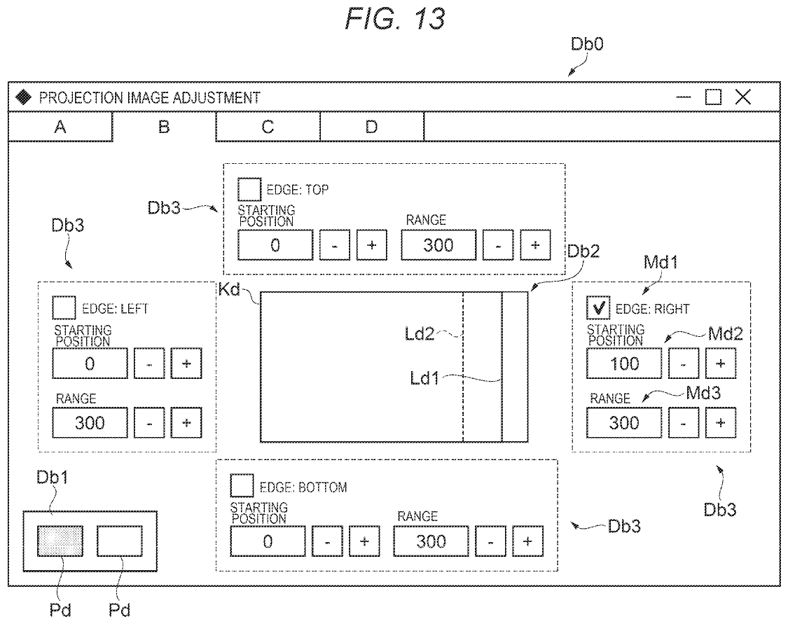

In the present embodiment, when the projection image adjustment program is started up, the controller 11 of the computer 1 makes the display device 14 display an operation image Db0 for adjusting the overlapping area as shown in FIG. 13. In an operation image Db0, there are included a selection image Db1 for selecting the projector 2 as the adjustment target, an adjustment image Db2 for adjusting the arrangement of the overlapping area Vo in the projection image Vp, and auxiliary images Db3 for helping the input operation for the adjustment. It is possible for the user to select the projector 2 as the adjustment target in the selection image Db1, and then designate a starting position and the width of the overlapping area Vo in the adjustment image Db2. For the selection of the projector 2, and the designation of the starting position and the width of the overlapping area Vo, there is used the input device 15 such as the keyboard 15a or the pointing device.

The selection image Db1 is substantially the same as the selection image Da1 in the first embodiment. In contrast, in the adjustment image Db2 in the present embodiment, there is displayed a rectangular figure Kd corresponding to the projection image Vp, and a start line Ld1 representing the starting position of the overlapping area Vo and an end line Ld2 representing an ending position of the overlapping area Vo are drawn on the figure Kd.

The auxiliary images Db3 are respectively arranged at an outer side of an upper circumferential edge of the figure Kd, at an outer side of a lower circumferential edge of the figure Kd, at an outer side of a right circumferential edge of the figure Kd, and at an outer side of a left circumferential edge of the figure Kd, and each of the auxiliary images Db3 includes a position designator Md1 for designating whether or not it is the circumferential edge provided with the overlapping area Vo, a starting position setter Md2 for setting the starting position of the overlapping area Vo, and a range setter Md3 for setting the width of the overlapping area Vo.

The position designator Md1 is formed of a check box, and the user checks the position designator Md1 in the circumferential edge where the overlapping area Vo is disposed using the input device 15. For example, when the projection images Vp are displayed side by side in the lateral direction as in the present embodiment, in the projection image Vp located at the left side, the overlapping area Vo is disposed at the right side. Therefore, when the user adjusts the overlapping area Vo of the projector 2 for projecting the projection image Vp located at the left side, the user checks the position designator Md1 in the auxiliary image Db3 located at the right side. The start line Ld1 and the stop line Ld2 on the adjustment image Db2 are drawn along the circumferential edge the position designator Md1 of which is checked.

In the starting position setter Md2 and the range setter Md3, there are displayed numerical values set by the user. It is possible for the user to directly input a numerical value with the keyboard 15a, and moreover, it is possible to increment and decrement the numerical value by performing a clicking operation on a “+” button and a “−” button arranged in the vicinity thereof. The numerical value set to the starting position setter Md2 is the number of pixels from the circumferential edge thus designated to the starting position of the overlapping area Vo, and on the adjustment image Db2, there is drawn the start line Ld1 at the position corresponding to the numerical value thus set. Further, the numerical value set to the range setter Md3 is the number of pixels from the starting position to the ending position of the overlapping area Vo, and on the adjustment image Db2, there is drawn the end line Ld2 at the position corresponding to the numerical value thus set. The starting position of the overlapping area Vo is set in accordance with an aspect ratio of the projection image Vp, namely the pixel area 32i, and an aspect ratio of the total image Vw, and the range from the circumferential edge to the starting position is set to a black color in the projection image Vp.

It should be noted that when the plurality of projection images Vp is arranged in the vertical direction and the horizontal direction to form a matrix, the overlapping areas Vo are disposed in a plurality of circumferential edges of one projection image Vp. Therefore, in this case, the user checks the position designators Md1 in the plurality of auxiliary images Db3.

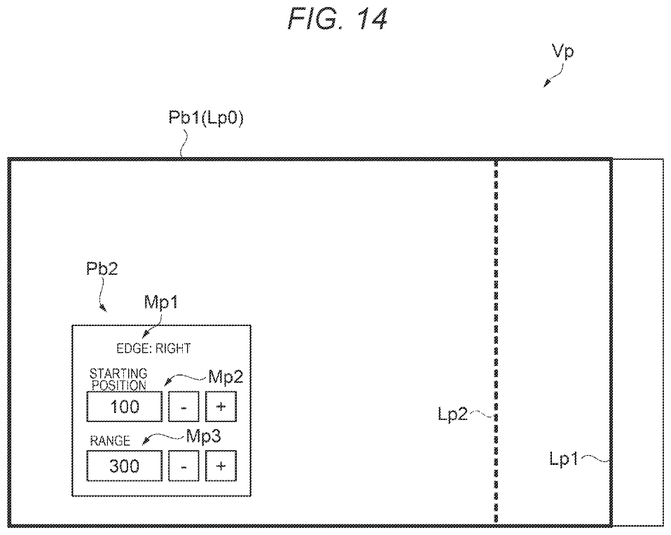

The controller 11 of the computer 1 makes the display device 14 display the operation image Db0, then transmits a control command to the projector 2 as the adjustment target via the communicator 13 to make the projecting unit 27 project an adjustment image Pb1 in which the adjustment result is reflected, and an auxiliary image Pb2 for helping the input operation for performing the adjustment as shown in FIG. 14. Images used as bases of these images are stored in advance in the storage 21 of the projector 2, and the controller 11 of the computer 1 designates these images using the control command to be transmitted. When the controller 20 of the projector 2 receives the control command from the computer 1, the controller 20 reads out the adjustment image Pb1 and the auxiliary image Pb2 designated by the control command from the storage 21, and then outputs these images to the image processor 26 to make the projecting unit 27 project these images on the projection surface Sp.

The adjustment image Pb1 projected by the projector 2 is an image corresponding to the adjustment image Db2 to be displayed on the display device 14, and includes a rectangular frame line Lp0. The frame line Lp0 includes a start line Lp1 corresponding to the start line Ld1 in the adjustment image Db2, and the frame line Lp0 is coupled to straight lines on the circumferential edges where the overlapping area Vo is not disposed to form the rectangular frame shape. Further, in the adjustment image Pb1, there is included an end line Lp2 corresponding to the end line Ld2 of the adjustment image Db2.

The auxiliary image Pb2 is displayed so as to be superimposed on the adjustment image Pb1. The auxiliary image Pb2 is an image corresponding to the auxiliary image Db3 in which the position designator Md1 is checked out of the auxiliary images Db3 displayed on the display device 14, and includes a position display Mp1 showing the circumferential edge where the overlapping area Vo is disposed, a starting position setter Mp2 for setting the starting position of the overlapping area Vo, and a range setter Mp3 for setting the width of the overlapping area Vo. A numerical value displayed in the starting position setter Mp2, and a numerical value displayed in the range setter Mp3 have the same values as the values displayed in the auxiliary image Db3. The controller 11 of the computer 1 includes these values in the control command and then transmits the control command to the computer 2. The controller 20 of the projector 2 recognizes the starting position and the width based on this control command, then generates the auxiliary image Pb2 in which these values are reflected in the starting position setter Mp2 and the range setter Mp3, and at the same time, draws the start line Lp1 and the end line Lp2 on the adjustment image Pb1. It should be noted that the controller 20 disposes the auxiliary image Pb2 at a position shifted from the start line Lp1 and the end line Lp2 so that the start line Lp1 and the end line Lp2 on the adjustment image Pb1, namely the positions to be the adjustment target on the adjustment image Pb1, are not covered by the auxiliary image Pb2.

Also in the present embodiment, substantially the same operation as in the first embodiment is performed in accordance with the flow shown in FIG. 5. In the present embodiment, the numerical value representing the starting position of the overlapping area Vo and the numerical value representing the width of the overlapping area Vo set by the user correspond to the adjustment parameters. The adjustment parameters are transmitted to the projector 2 in the step S109, and are then stored in the storage 21 of the projector 2. Further, when the projector 2 performs the projection of the content image, the image processor 26 performs the processing of decreasing the luminance on the overlapping area Vo represented by the adjustment parameters.

As described hereinabove, according to the computer 1 and the adjustment method related to the present embodiment, advantages substantially the same as those in the first embodiment can be obtained.

It should be noted that in the embodiment described above, the auxiliary image Db3 to be displayed on the display device 14 and the auxiliary image Pb2 to be projected by the projector 2 correspond to the first image, and the adjustment image Pb1 to be projected by the projector 2 corresponds to the second image.

Further, the embodiments described above can also be modified as follows.

In the embodiments described above, by arranging that a pointer (not shown) of the pointing device displayed on the display device 14 is also displayed in the projection image Vp, it becomes easy to operate the pointing device while watching the projection image Vp, and it is possible to further reduce the frequency of the user looking at the display device 14. It should be noted that in order to display the pointer in the projection image Vp, it is possible to arrange that the controller 11 captures an image including the pointer to transmit the image to the projector 2, or it is possible to arrange that the controller 11 transmits the coordinate of the pointer to the projector 2 to make the projector 2 draw the pointer.

In the embodiments described above, the adjustment images Pa1, Pb1 and the auxiliary images Pa2, Pb2 are generated in the projector 2 based on the images stored in the storage 21 of the projector 2, but this aspect is not a limitation. It is possible to arrange that the computer 1 generates the adjustment images Pa1, Pb1 and the auxiliary images Pa2, Pb2, and transmits these images to the projector 2 to make the projector 2 project these images.

In the embodiments described above, there is shown the configuration in which the computer 1 and the plurality of projectors 2 are coupled to each other, but the number of the projectors 2 to be coupled is not limited to two or more, and can also be just one. In particular, in an aspect of correcting the geometric distortion shown in the first embodiment, the present disclosure is advantageous even when the adjustment target is just one projector 2. Further, the connection configuration is not limited to the connection via the network NW, and it is possible to adopt a variety of types of wired connection and a variety of types of wireless connection.

In the embodiments described above, there is illustrated the adjustment processing for correcting the geometric distortion and the adjustment processing related to the arrangement of the overlapping area Vo as the projection image adjustment processing, but the projection image adjustment processing is not limited thereto. For example, it is possible to adopt processing of adjusting the color and the luminance of the projection image Vp.

In the embodiments described above, the auxiliary images Pa2, Pb2 to be displayed by the projector 2 and the auxiliary images Da3, Db3 to be displayed by the display device 14 are not required to be completely the same in content as each other as long as these images include common information. For example, it is possible for the auxiliary images Pa2, Pb2 to include only a part of the information included in the auxiliary images Da3, Db3, or include other information than the information included in the auxiliary images Da3, Db3.

Although in the embodiments described above, the transmissive liquid crystal light valves 32R, 32G and 32B are used as the light modulation devices, it is also possible to use reflective light modulation devices such as reflective liquid crystal light valves. Further, it is also possible to use a digital mirror device or the like for modulating the light emitted from the light source 31 by controlling the emission direction of the incident light for every micromirror as a pixel. Further, the configuration of providing the plurality of light modulation devices for the respective colored light beams is not a limitation, but it is also possible to adopt a configuration of modulating the plurality of colored light beams with a single light modulation device in a time-sharing manner.

In the embodiments described above, there is shown the configuration of performing the adjustment of the projectors 2, but the display device as the adjustment target is not limited to the projector 2, and can also be other display devices such as a liquid crystal display or an organic EL (Electro Luminescence) display.

What is claimed is:

1. An adjustment method comprising:
displaying, by a first display device, a first image used to help an input operation for performing an adjustment of a second display device different from the first display device;
displaying, by the second display device, the first image and a second image in which a result of the adjustment is reflected; and
outputting an adjustment parameter used to perform the adjustment to the second display device based on the input operation.

2. The adjustment method according to claim 1, wherein
the displaying, by the second display device, the first image and the second image includes superimposing the first image on a position different from a position where the adjustment is performed in the second image.

3. The adjustment method according to claim 1, further comprising:
displaying, by the first display device and the second display device, a third image of giving notice of an error when the error occurs due to the input operation.

4. The adjustment method according to claim 1, wherein
the second display device is a projector, and
the adjustment is an adjustment for correcting a geometric distortion of a projection image projected by the second display device.

5. An adjustment device comprising:
at least one processor configured to execute
displaying, using a first display device, a first image used to help an input operation for performing an adjustment of a second display device different from the first display device,
displaying, using the second display device, the first image and a second image in which a result of the adjustment is reflected, and
outputting an adjustment parameter used to perform the adjustment to the second display device based on the input operation.
